(19) United States
(12) Patent Application Publication
(10) Pub. No.: US 2025/0358320 A1
(43) Pub. Date: Nov. 20, 2025

(54) METHOD FOR MODEL-BASED IDENTITY AND ACCESS MANAGEMENT ATTRIBUTE INGESTION AND NORMALIZATION

(71) Applicant: Also Known As, Inc., San Mateo, CA (US)

(72) Inventors: Robert Fry, Austin, TX (US); William Lin, San Francisco, CA (US); Joshua Scott, Erie, CO (US); Scott Woods, Ipswich, MA (US); Joshua Williams, Austin, TX (US)

(21) Appl. No.: 19/209,214

(22) Filed: May 15, 2025

Related U.S. Application Data
(60) Provisional application No. 63/648,123, filed on May 15, 2024.
(60) Provisional application No. 63/686,449, filed on Aug. 23, 2024.
(60) Provisional application No. 63/714,640, filed on Oct. 31, 2024.
(60) Provisional application No. 63/778,859, filed on Mar. 27, 2025.

(51) Int. Cl. H04L 9/40

(52) U.S. Cl. CPC H04L 63/20

(57) ABSTRACT

One variation of the method includes: accessing a set of objects generated by a set of sources connected to a computer network, the set of objects including an object defining: a source field; and a source attribute value corresponding to the source field; defining a transformation between the source field and a standard field based on a transform model; identifying an identity characterized by the source attribute value; storing the source attribute value in an identity container representing the identity, the source attribute value corresponding to the standard field; identifying a policy valid for the identity based on the identity container; calculating a posture score for the identity based on correspondence between the policy and the source attribute value; and, in response to the posture score exceeding a threshold posture score, flagging the identity for review by security personnel associated with the computer network.

### CROSS-REFERENCE TO RELATED APPLICATIONS

This application claims the benefit of U.S. Provisional Application No. 63/648,123, filed on 15 May 2024, which is incorporated in its entirety by this reference.

This application is related to U.S. Provisional Application No. 63/610,630, filed on 15 Dec. 2023, which is incorporated in its entirety by this reference.

### TECHNICAL FIELD

This invention relates generally to the field of identity and access management and, more specifically, to a new and useful method for model-based identity and access management attribute ingestion and normalization within the field of identity and access management.

### BRIEF DESCRIPTION OF THE FIGURES

FIGS. 1A and 1B are flowchart representations of a method;

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

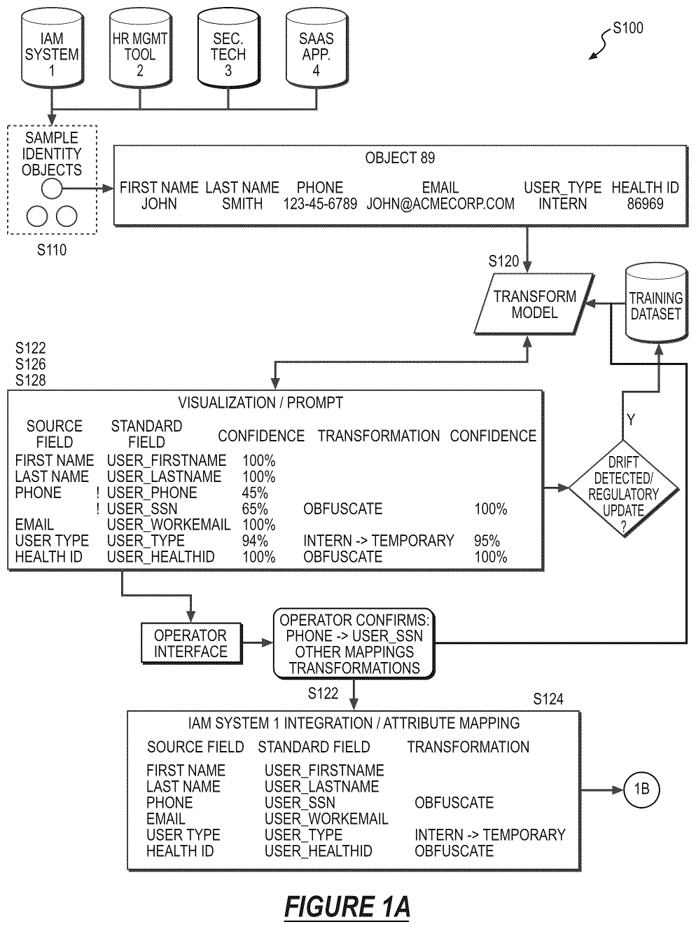

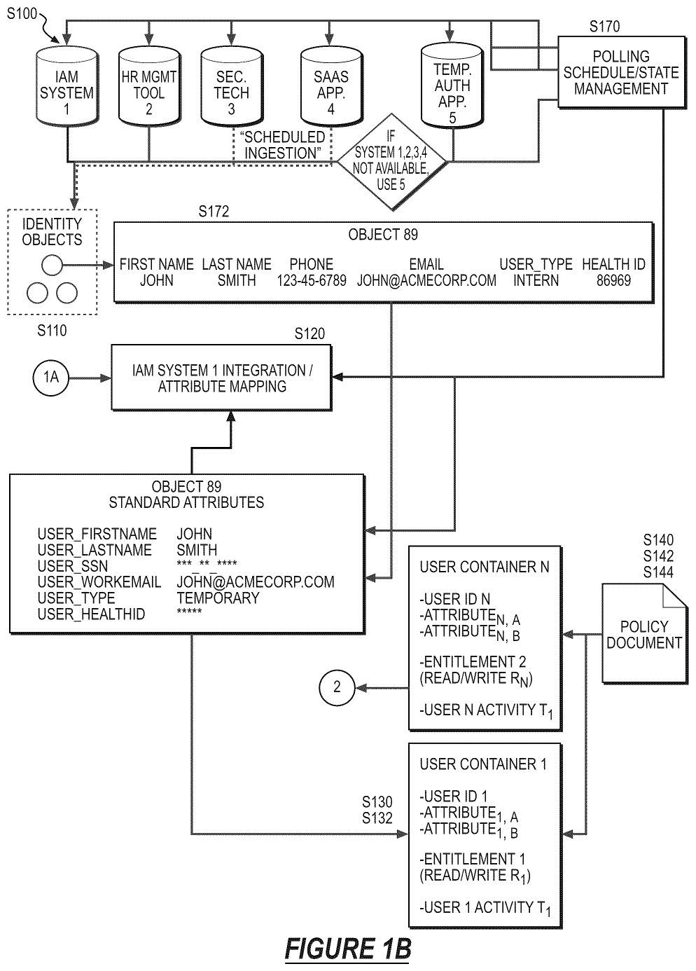

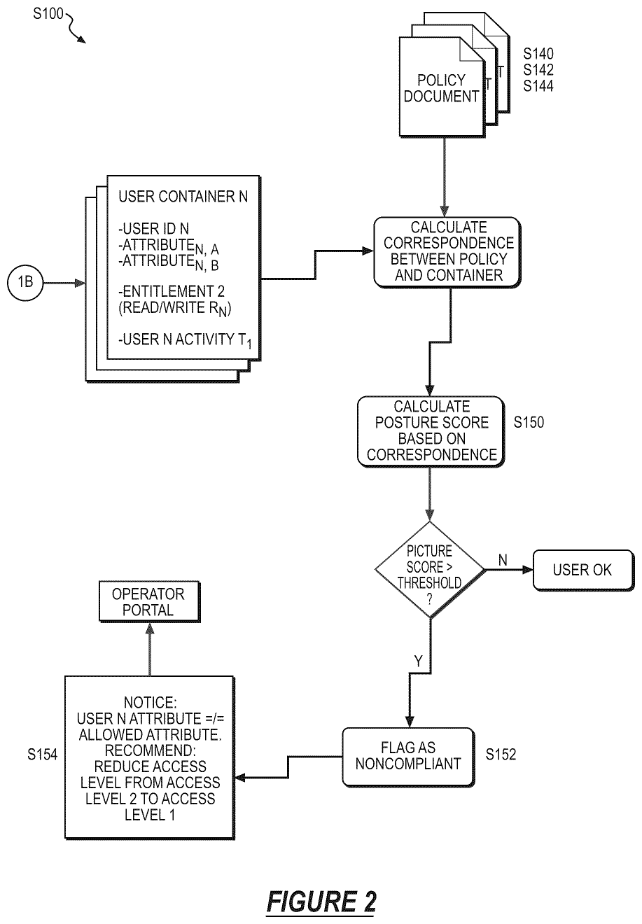

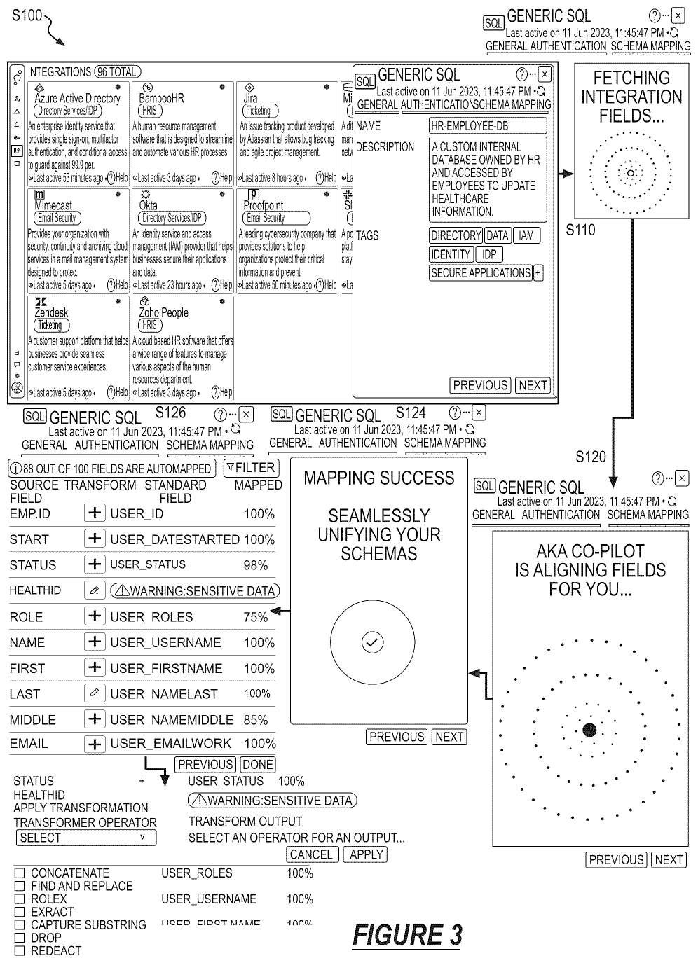

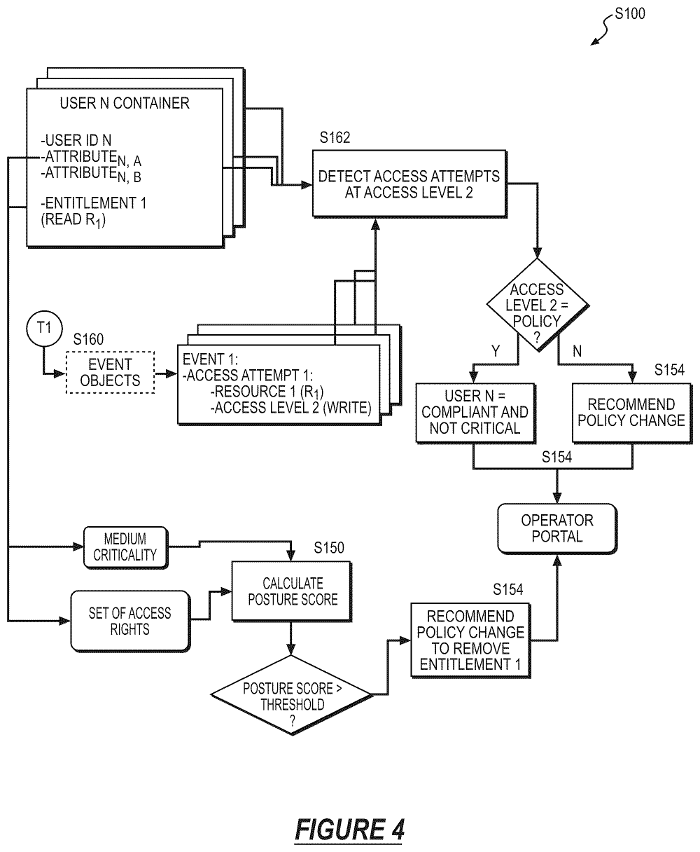

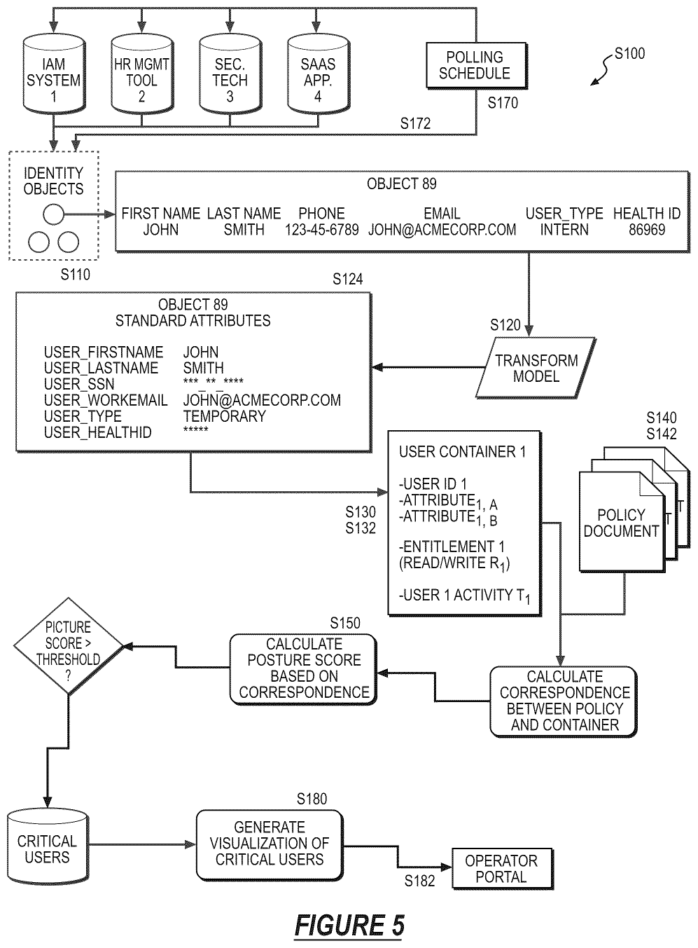

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

As shown in the FIGURES, a method S100 includes: accessing a first set of objects generated by a first set of sources connected to a computer network during a first time interval in Block S110, the first set of objects including a first object generated by a first source and representing a first attribute defining a first source field and a first source attribute value corresponding to the first source field; accessing a transform model that correlates source formats with a standard format in Block S120; defining a first transformation between the first source field and a first standard field based on the transform model in Block S122; mapping the first source attribute value to the first standard field in Block S124; identifying a first identity, characterized by the first source attribute value, in a set of identities associated with the computer network in Block S130; storing the first source attribute value in a first identity data container representing the first identity, the first source attribute value corresponding to the first standard field in Block S132; accessing a set of policies associated with the computer network, the set of policies governing identity permissions and actions within the computer network in Block S140; identifying a first policy, in the set of policies, valid for the first identity based on the first identity data container in Block S142; calculating a first posture score for the first identity based on correspondence between the first policy and the first source attribute value in Block S150; and, in response to the first posture score exceeding a threshold posture score, flagging the first identity for review by security personnel associated with the computer network in Block S152.

### 1.1 Variation: Confidence Scores

In one variation, the method S100 includes: accessing a first set of objects generated by a first set of sources associated with a computer network during a first time interval in Block S110, the first set of objects including a first object generated by a first source and defining a first source field and a first source attribute value corresponding to the first source field; accessing a transform model that correlates target attributes in a target source format with standard attributes in a standard format in Block S120; calculating a first confidence score for a first standard field based on the transform model and the first source field in Block S126; and defining a first transformation between the first source field and the first standard field, for the first source, in response to the first confidence score exceeding a first confidence score threshold in Block S122.

This variation of the method S100 includes, for a first identity, in a set of identities, associated with the computer network: identifying a first mapping between the first source attribute value and the first identity in Block S124; calculating a second confidence score for the first mapping; in response to the second confidence score exceeding a second confidence score threshold, storing the first source attribute value in a first identity data container representing the first identity, the first source attribute value corresponding to the first standard field in Block S132; accessing a set of policies associated with the computer network in Block S140; identifying a first policy, in the set of policies, valid for the first identity based on the first identity data container in Block S142; calculating a first posture score based on correspondence between the first policy and the first source attribute value in Block S150; and, in response to the first posture score exceeding a threshold posture score, flagging the first identity for review by security personnel associated with the computer network in Block S152.

### 1.2 Variation: Mapping

As shown in the FIGURES, a method S100 includes accessing a first set of objects generated by a first source connected to a computer network during a first time interval, including a first object and a second object, in Block S110. The first object represents a first attribute of a first user accessing the computer network during the first time interval, the first attribute defining a first source field and a first source attribute value corresponding to the first source field. The second object represents a second attribute of a second user accessing the computer network during the first time interval, the second attribute defining the first source field and a second source attribute value corresponding to the first source field.

The method S100 also includes: accessing a transform model that correlates target attributes in a target source format with standard attributes in a standard format in Block S120; extracting the first source field from the first object; identifying a first candidate standard field associated with a first attribute type and corresponding to the first source field based on the transform model; accessing a first confidence score threshold associated with the first candidate standard field based on the first attribute type; and calculating a first confidence score for the first candidate standard field based on the transform model in Block S126.

The method S100 further includes: extracting the first source attribute value from the first object; extracting the second source attribute value from the second object; identifying a second candidate standard field associated with a second attribute type and corresponding to the first source attribute value and the second source attribute value based on the transform model, the second candidate standard field different from the first candidate standard field; calculating a second confidence score for the second candidate standard field based on the transform model; accessing a second confidence score threshold associated with the second candidate standard field based on the second attribute type, the second confidence score threshold exceeding the first confidence score threshold; calculating a first composite confidence score for the first candidate standard field based on the first confidence score and the second confidence score in Block S126; in response to the first composite confidence score exceeding the first confidence score threshold and falling below the second confidence score threshold, prompting an operator to confirm a first mapping between the first source field and the first candidate standard field; and defining the first mapping between the first source field and the first candidate standard field in response to confirmation of the first mapping by the operator in Block S122.

The method S100 also includes: extracting the first source attribute value from the first object; identifying a first candidate transformation for the first source attribute value based on the transform model and the first standard field; accessing a second confidence score threshold based on the first attribute type; and calculating a third confidence score for the first candidate transformation.

The method S100 further includes, in response to the third confidence score falling below the third confidence score threshold: generating a first candidate standard value based on the first source attribute value and the first candidate transformation; prompting the operator to confirm the first candidate transformation based on the first candidate standard value; and associating the first candidate transformation with the first mapping in response to confirmation of the first candidate transformation by the operator.

The method S100 also includes: extracting the second attribute from the second object; in response to detecting the first source field defined by the second attribute, accessing the first mapping; generating a second standard attribute value based on the second source attribute value defined by the second attribute and the first transformation associated with the first mapping; transforming the second attribute into a second standard attribute based on the first mapping, the second standard attribute defining the first standard field and the second standard attribute value; and storing the second standard attribute in a user container associated with the second user in Block S132.

### 2. Applications

Generally, a computer system can execute Blocks of the method S100: to aggregate objects (e.g., records) from various disparate sources (e.g., identity and access management systems, security technologies, human resources management tools)—affiliated with, deployed within, and/or supporting computer networks within an organization—during a target time interval: to extract source data from these objects, such as source fields and source attribute values, representing attributes of identities (e.g., accounts, roles, users, groups) connected to the computer network; to map these source data to a standardized form, such as by mapping source attribute values to normalized standard fields; to identify a particular identity represented by an attribute (or a set of attributes) derived from these objects; to aggregate these attributes, represented by attribute source values, into a data container associated with the identity; to identify policies that apply to (e.g., govern) this identity based on these attributes that characterize the identity's activities, responsibilities, and access within the organization; and to evaluate the identity's compliance with these policies.

More specifically, the computer system can execute Blocks of the method S100: to identify a set of identities (e.g., users, roles, groups) within a computer network based on objects collected across multiple software tool sources; to ingest policies (e.g., in a policy document) defined by the organization; to extract or derive entitlements—representing permissions granted to particular identities to access resources connected to the computer network—from these policies; and to automatically map these entitlements to identities operating on computer networks in order to detect policy violations and/or control access to resources by specific identities and thus by specific personnel (or “users”) affiliated with these identities. The computer system can further execute Blocks of the method S100 to: track activity—performed or initiated by each identity in the set of identities—on resources connected to the computer network during the target time interval; detect deviations between a) these activities and b) entitlements mapped to identities that originated these activities; generate recommendations for responding to these deviations, such as changes to these policies or changes to roles and access assigned to users within the organization; and serve these recommendations to an operator via an operator portal.

For example, the computer system can execute Blocks of the method S100: to access a set of records from a first identity and access management system; to access a first record that identifies a first user as a “student” user type; to access a second record that identifies a second user as an “intern” user type; to interpret the first user and the second user as corresponding to a “temporary employee” user type defined in a policy document; and to map entitlements—corresponding to “temporary employee” users—to the first user and the second user according to the policy document.

Therefore, the computer system can execute Blocks of the method S100: to ingest identity and access management data from different sources; and to interpret and unify these data—that may exhibit a different format and/or lexicon for each source—into a standard format and/or lexicon in order to accurately identify and characterize users connected to the computer network, thereby enabling the computer system to correctly apply policies to these users.

Therefore, the computer system can integrate with these disparate sources (e.g., SIEMs, inventory tools, third-party sources) to: extract sets of objects from these sources, generated during target time periods; derive schema maps from these sets of objects to transform attributes, defined by the set of objects, into a standard form; and automatically update these attributes based on polling the sources according to a particular frequency.

### 2.1 Attribute Mapping and Interface

More specifically, the computer system can execute Blocks of the method S100: to access a model (e.g., an algorithm, a pre-trained language model, a transform model) that correlates target attributes in a target format with standard attributes in a standard format; to access a first sample record(s) published by a target source; to extract a data field from the sample record, the data field representing an attribute of a first identity (e.g., user, account); to correlate the data field to a set of candidate standard fields based on the model; to calculate confidence scores, representing accuracy of (or confidence in) candidate standard fields, for each of the candidate standard fields based on the model; and to define a first mapping between the data field and a particular candidate standard field based on the first confidence score. The computer system can repeat these Blocks of the method S100 for each data field in the sample record.

For example, the computer system can execute Blocks of the method S100: to extract the first data field labeled “phone” from the first record; to extract a first data value—associated with the first data field—labeled “123-45-6789” from the first record; to interpret the first data field as corresponding to a “phone number” attribute type based on the model; to identify a first candidate standard field of “user_phone” corresponding to the “phone number” attribute type; to calculate a first confidence score for the first candidate standard field; to interpret the first data value as corresponding to a “social security number” attribute type based on the model; to identify a second candidate standard field of “user_ssn” corresponding to the “social security number” attribute type; and to calculate a second confidence score for the second candidate standard field.

In this example, the computer system can execute Blocks of the method S100 to generate a visualization depicting: the first data field labeled “phone”; the first data value labeled “123-45-6789”; the first candidate standard field of “user_phone”; the first candidate score; second candidate standard field of “user_ssn”; and/or the second confidence score. Then, the computer system can execute Blocks of the method S100: to serve the visualization to an operator; and to prompt the operator to select the first candidate standard field or the second candidate standard field as a correct standard field for the first data field. The computer system can execute Blocks of the method S100 to define a mapping between the first data field and the second candidate standard field based on selection from the operator.

Accordingly, in this example the computer system can execute Blocks of the method S100: to interpret the first data field as corresponding to a phone number; to interpret the first data value as corresponding to a social security number; to prompt the operator to confirm that the first data value corresponds to a social security number (rather than a phone number); and to map the first data field—labeled “phone”—to the second candidate standard field of “user_ssn.”

Therefore, the computer system can: automatically normalize data from disparate sources, defining unique source field schema, to a normalized standard field schema; and automatically attribute (e.g., map) these data to the correct identity in a set of identities connected to the computer network to thereby enable the computer system to identify policies applying to this identity and later evaluate compliance of this identity to the policy.

### 2.2 Attribute Mapping and Posture

In one implementation, the computer system can execute Blocks of the method S100 to calculate a posture score characterizing a risk (e.g., security risk, operational risk) posed to the computer network and attributed to an identity based on attributes of this identity, such as: access rights granted to this identity; access levels associated with access attempts (e.g., event data) associated with this identity; number of accounts attributed to this identity; sensitivity of data that may be accessed by the identity (and therefore may be accessed by a bad actor controlling an account/many accounts attributed to this identity); and/or other attributes associated with (e.g., attributed to) this identity. In particular, the computer system can: interpret policies, as described herein, to identify requirements (e.g., permissions) granted to identities connected to the computer network, such as by extracting entitlements and/or other configurations that govern identity actions and/or attributes; identify a particular policy governing a particular identity, such as based on the contents of this policy; and evaluate compliance of the particular identity to this particular policy by calculating a posture score for the identity based on correspondence between the attributes of the identity, detected by the set of sources and extracted from the set of objects generated by the set of sources, and the particular policy. Then, in response to the posture score exceeding a threshold posture score, the computer system can: identify the identity as noncompliant with the policy; flag the identity for review by security personnel associated with the computer network; and/or generate a recommendation to reduce the posture of this identity, such as by reducing access rights granted to this identity.

In one example, in response to the posture score exceeding the threshold posture score, the computer system can then: identify a subset of access rights included in the set of access rights granted to the first identity and excluded from a target subset of access rights associated with entities assigned the first role; generate a notification recommending removal of this subset of access rights from the set of access rights granted to the first identity; and serve the notification to an operator.

Therefore, the system can execute Blocks of the method S100: to identify an identity (e.g., entity) posing relatively high risk to the computer network based on normalized attributes associated with this identity (e.g., an amount of access granted to the identity and a criticality level assigned to the entity); and to recommend actions based on this high risk and/or policy violation (e.g., removal of access to certain resources from the entity in order to correct over-provisioning of access assigned to this entity), thereby reducing risk in the computer network.

### 3. Terminology

Generally, an “entity” is referred to herein as a discrete actor within an organization.

Generally, an “identity” is referred to herein as a representation of an entity on the computer network.

Generally, a “user” and/or an “account” is referred to herein as an identity representing a unique entity.

Generally, a “group” is referred to herein as an identity representing a collection of users.

Generally, a “role” is referred to herein as an identity-representing a class of users-assignable to one or more users.

Generally, an “entitlement” is referred to herein as a permission-assigned to an identity-defining an action the identity may perform, data the identity may access, and/or a resource(s) the identity may control, etc.

Generally, a “criticality level” is referred to herein as an importance of an entity, an identity, a resource, etc. within an organization and/or the organization's computer network.

Generally, an “access level” (or an “access right”) is referred to herein as a particular right granted by an entitlement, to an identity, representing specific actions the identity may execute on resources on the organization's computer network, such as read, write, execute, etc.

### 4. Computer Network and Sources

Generally, various entities (e.g., human individuals, computer processes, software applications) may exhibit identities as users in an organization's computer network. Users (represented by identities) may access resources within and/or connected to an organization's computer network, such as: compute resources (e.g., workstations, laptops, servers, printers, smartphones); network resources (e.g., modems, gateways, routers, access points, subnets); data resources (e.g., storage volumes, databases, files); etc.

Sources—such as identity and access management systems, security technologies, human resources management tools, software-as-a-service (or “SaaS”) applications, productivity tools, etc.—may be deployed on (and/or interface with) devices (e.g., compute resources, network resources) in the computer network, and the sources can generate data based on communication with these devices. For example, a source can generate objects representing attributes of resources connected to the computer network at a target time (or during a target time interval). Additionally or alternatively, a source can generate objects representing attributes of users—extant on the computer network and/or accessing resources connected to the computer network—at the target time (or during the target time interval).

In one implementation, the computer system can ingest a first set of objects, representing identity data, from a first set of sources (e.g., authoritative systems, Human Resource Information Systems). In response to absence of the set of objects and/or prevention of access to the first set of sources, the computer system can query a second set of sources (e.g., alternative authoritative systems, Active Directory) for a second set of objects representing identity data for the computer network and approximating the first set of objects. In particular, the computer system can temporarily integrate with the second set of sources while establishing integration with the first set of sources. In response to completion of integration with the first set of sources, the computer system can: validate the second set of objects based on the first set of objects; merge the second set of objects with the first set of objects; and/or replace the second set of objects with the first set of objects.

In one implementation, the computer system can: prompt a user to select a particular source, connected to the computer network, to integrate (e.g., interact) with the computer system; authenticate the user (e.g., via a passcode); and poll the particular source of objects, representing attributes of identities associated with the computer network, generated during a target time period. The computer system can then implement the method S100 and techniques described below to: access objects from the resource representing a set of attributes; map the set of attributes to standardized attribute fields; map attributes to identities; and aggregate identity attributes into identity data containers. Accordingly, in this implementation, the computer system can automatically access these objects via direct communication with the source in response to selection of the source and authentication of a user.

In particular, in this implementation, the computer system can implement message-queuing and/or caching to receive and process objects received from sources. For example, in response to detecting an interface error and/or partial upload of a set of objects form a set of sources, the computer system can: identify a first source, in the set of sources, associated with the interface error; process a subset of sources, excluding the first source, for a subset of objects; and access historical objects associated with the first source to identify a source of the interface error and generate a recommendation for error resolution.

In one implementation, the computer system can implement horizontal scaling to ingest objects from a set of sources (e.g., 100 sources). In particular, the computer system can implement a first processing layer (e.g., caching layer) to derive a first set of characteristics (e.g., identities) from the set of objects upon data ingestion.

In one implementation, the computer system can poll these sources for objects generated during target time intervals based on a pre-defined polling schedule and/or frequency. In particular, in this implementation, the computer system can: access a query schedule specifying a polling frequency for the first set of sources in Block S170; and query the first set of sources, according to the polling frequency, for objects generated during a target time interval based on the query schedule in Block S172. Furthermore, in this implementation, the computer system can: access a second set of objects generated by the first set of sources during a second time interval based on the query schedule, the second set of objects including a second object generated by a second source and representing a second attribute defining a second source field and a second source attribute value corresponding to the second source field; define a second transformation between the second source field and the first standard field based on the transform model; map the second source attribute value to the first standard field; identify the first identity based on the second source attribute value; and store the second source attribute value in the first identity data container representing the first identity, the second source attribute value corresponding to the first standard field.

Therefore, the computer system can integrate with these disparate sources (e.g., SIEMs, inventory tools, third-party sources) to: extract sets of objects from these sources, generated during target time periods; derive schema maps from these sets of objects to transform attributes, defined by the set of objects, into a standard form; and automatically update these attributes based on polling the sources according to a particular frequency.

### 4.1 Object Format

Generally, a source can generate an object representing a set of attributes of an identity (e.g., a user, an account, a role).

In one implementation, for each attribute in the set of attributes, the source can generate the object defining: a source field representing an attribute type of the attribute; and a source attribute value. In this implementation, the source can generate the object—defining the source field and the source attribute value—exhibiting a particular format and/or lexicon.

In one example, a first source generates a first object including a first source field (e.g., “user_type”) and a first source attribute value (e.g., “temp”) in a first format. In another example, a second source generates a second object including a second source field (e.g., “usertype”) and a second source attribute value (e.g., “intern”) in a second format.

### 4.2 Source Integration: Schema Mapping

Generally, the computer system can: extract a set of objects generated by a source and representing a set of attributes of identities connected to the computer network; detect a first schema representing organization of the set of objects; and generate a mapping, based on the first schema, to map the set of attributes, represented by the set of objects, to a standard form.

For example, the computer system executes the method S100 and techniques described in U.S. patent application Ser. No. 18/983,148 to access a set of objects generated by a source during a target time interval. Then, for each object in the set of objects, the computer system: extracts a set of attributes represented by the object; identifies a user associated with the set of attributes; accesses (or generates) a user container (or data container) corresponding to the user; and stores the set of attributes in the user container.

In one implementation, the computer system executes methods and techniques described in U.S. patent application Ser. No. 18/983,148 to store a set of attributes—represented by an object generated by a first source—into the user container by: accessing a first schema defining a first format and/or a first lexicon for attributes represented in objects generated by the first source; interpreting the set of attributes based on the first schema; and compiling the set of attributes into the user container according to a second schema defining a second format (e.g., a standard format) and/or a second lexicon (e.g., a standard lexicon).

In another implementation, the computer system generates a set of mappings that transform attributes represented in objects generated by a source (or “source attributes”)—that exhibit a first format (or “source format”)—into standard attributes that exhibit a second format (or “standard format”).

More specifically, the computer system can generate a first mapping between a first source field—defined in a first source attribute and exhibiting the source format—and a first standard field exhibiting the standard format.

Additionally, the computer system can generate a second mapping between a first source attribute value—defined in the first source attribute and exhibiting the source format—and a first standard attribute value exhibiting the standard format. Additionally or alternatively, the computer system can: identify a first transformation that transforms the first source attribute value into the first standard attribute value; and associates the first transformation with the first mapping and/or the second mapping.

The computer system can repeat the foregoing methods S100 and steps for each attribute in a set of attributes defined in an object generated by the first source. Additionally, the computer system can repeat the foregoing methods S100 and steps for each object in the first set of objects generated by the first source.

The computer system can repeat the foregoing methods S100 and steps for each source in the set of sources connected to (or included in) the computer network.

Accordingly, by generating the set of mappings that transform source attributes into standard attributes, the computer system can process and unify object data—published by disparate sources—in a consistent manner in order to correctly identify users connected to the computer network and/or characterize attributes of these users.

### 4.3 Object Types: Event Data

In one implementation, the computer system can access a set of objects (e.g., event objects) generated by a second set of sources and representing event data on the computer network. In particular, the computer system can access objects representing event data, such as activity (e.g., access attempts, login attempts, policy changes, resource provisioning) performed by an identity (e.g., an account) with a particular resource connected to the computer network, from a second set of sources (e.g., authentication systems; access management and IAM Platforms; operating systems and endpoints; cloud infrastructure logs; application logs).

In one implementation, the computer system can: access a second set of objects generated by a second set of sources connected to the computer network during the first time interval, the second set of objects representing activity associated with the first identity interacting with a set of resources on the computer network in Block S160; detect a first set of access attempts associated with a first resource by the first identity based on the second set of objects, the first set of access attempts characterized by a first access level in Block S162; extract a target access level from the first policy, the target access level valid for the first identity; in response to detecting a deviation between the first access level and the target access level, generate a prompt to review the first access level for the first identity based on the first policy in Block S152; and transmit the prompt to an operator via an operator interface.

For example, in this implementation, the computer system can: access event data from disparate sources connected to the computer network; extract a set of access attempts from this event data, the set of access attempts representing access attempts (e.g., login attempts, click attempts, edit attempts) to a first resource on the computer network and characterized by a first access level (e.g., edit); extract (or identify) a target access level (e.g., read) associated with the first identity and the first resource, such as a target access level granted by an entitlement defined in a first policy; detect a deviation between the first access level in the event data and the target access level; and, in response to detecting the deviation, prompt an operator to review the first access level and/or recommend updating the first access level to the target access level in Block S154.

In another example, the computer system can: characterize the first set of access attempts as hacking attempts based on the deviation between the first access level and the target access level; detect a set of accounts associated with the first identity based on the first identity data container; and, in response to characterizing the first set of access attempts as hacking attempts, quarantine the set of accounts. In particular, the computer system can characterize the first set of access attempts as hacking attempts based on the first access level exceeding a threshold access level, and/or in response to detecting a count of access attempts (e.g., 100), in the first set of access attempts, exceeding a threshold count of access attempts (e.g., 10) during a target time period.

In one implementation, the computer system: accesses a first event object in the set of event objects; and detects a first event—represented by the first event object—representing an access (e.g., a read access, an attempted write access) to a first resource by a first account in the set of accounts.

For example, the computer system can: detect a first event—represented by the first event object—representing an attempted write access to a first folder by a first account identifier associated with the first account; and correlate the first event with the first account based on the first account identifier. Additionally, the computer system can detect a policy violation associated with the first event based on a first entitlement—assigned to the first account—specifying read-only access to the first folder by the first account. In this example, the computer system can: access the first account profile associated with the first account; and store, into the first account profile, the first event and an indication of the policy violation associated with the first event.

The computer system can repeat the foregoing methods and techniques for each event object in the set of event objects to identify events and/or policy violations detected during the target time interval.

### 5. Transform Model

In one implementation, the computer system accesses (or generates) a transform model (e.g., an algorithm, a pre-trained language model) that correlates source attributes—in a source format—with standard attributes in a standard format (or “normalized” format). In particular, the computer system can access a transform model that correlates source formats with a standard format by defining a set of mappings, each mapping in the set of mappings correlating a particular source field, associated with a particular source, to a standard field.

More specifically, the computer system can access the transform model that: correlates a target source field in the target format with a standard field in the standard format; and generates a first confidence score for the standard field.

Additionally or alternatively, the computer system can access the transform model that: correlates a target source attribute value in the target format with a standard attribute value in the standard format; and generates a second confidence score for the standard attribute value.

In one variation, the computer system accesses the transform model that: correlates the target source field with a particular attribute type in a set of attribute types; and identifies the standard source field (and/or the standard attribute value) based on the particular attribute type. For example, the computer system can access the transform model that: correlates the target source field with the particular attribute type in a set of attribute types; identifies a transformation for a target source attribute value based on the particular attribute type; and generates the standard attribute value by transforming the target source attribute value according to the transformation.

### 5.1 Model Training+Generation

In one implementation, the computer system: accesses a training dataset correlating target attributes with standard attributes; and trains the transform model based on the training dataset.

In one example, the computer system: accesses a first training dataset defining example source fields labeled with standard fields; accesses a second training dataset defining example source attribute values labeled with standard attribute values; and trains the transform model based on the first training dataset and the second training dataset.

In another example, the computer system: accesses a first training dataset defining example source fields—and example source attribute values—labeled with example attribute types; accesses a second training dataset defining example attribute types labeled with standard fields and standard attribute values; and trains the transform model based on the first training dataset and the second training dataset.

In one variation, the computer system can generate the transform model based on ingested data from the set of sources connected to the computer network in Block S128. In particular, the computer system can access a second set of objects generated by the first set of sources connected to the computer network during a second time interval, the second set of objects including: a second object generated by the first source and representing a second attribute defining a second source field and a second source attribute value corresponding to the second source field; and a third object generated by the first source and representing a third attribute defining a third source field and a third source attribute value corresponding to the third source field. The computer system can then: identify a candidate standard field corresponding to the second source field and the third source field based on correspondence between the second source attribute value and the third source attribute value; calculate a first confidence score for the candidate standard field based on the second source attribute value; calculate a second confidence score for the candidate standard field based on the third source attribute value; calculate a composite confidence score for the candidate standard field based on the first confidence score and the second confidence score; in response to the first composite confidence score falling below a first confidence score threshold, prompt an operator to confirm a first mapping between the second source field and the candidate standard field and a second mapping between the third source field and the candidate standard field; define the first mapping between the second source field and the candidate standard field in response to confirmation of the first mapping by the operator; define the second mapping between the third source field and the candidate standard field in response to confirmation of the second mapping by the operator; and generate the transform model based on the first mapping and the second mapping.

Accordingly, in this variation, the computer system can generate the transform model, defining a set of mappings, based on operator confirmation of these mappings based on confidence scores generated for these mappings. Additionally or alternatively, the computer system can, in response to the first composite confidence score exceeding the first confidence score threshold, define a first mapping between the second source field and the candidate standard field and a second mapping between the third source field and the candidate standard field; and generate the transform model based on the first mapping and the second mapping. Therefore, in this variation, the computer system can automatically generate the transform model and/or the set of mappings based on confidence scores associated with these mappings exceeding a threshold confidence score, and/or in response to operator confirmation in response to these confidence scores associated with these mappings falling below the threshold confidence score.

### 6. Source-Standard Field Mapping Schema

Generally, the computer system can: access the transform model; access an object generated by a target source; extract a set of source fields from the object; identify a set of candidate standard fields-corresponding to the set of source fields-based on the transform model; calculate a set of confidence scores for the set of candidate standard fields; and define a set of mappings between source fields and candidate standard fields. The computer system can generate a schema for transforming attributes—represented in objects generated by the target source—into standard attributes based on the set of mappings.

The computer system can: generate a visualization depicting the set of mappings between source fields and candidate standard fields and the set of confidence scores for the set of candidate standard fields; and serve the visualization to an operator via an operator interface.

### 6.1 Candidate Standard Field

In one implementation, the computer system accesses a first set of objects generated by a first source. Each object in the first set of objects represents a set of attributes of a user in a set of users. Each attribute defines a source field and a source attribute value corresponding to the source field and specific to the user.

For example, the computer system can: access a first object defining a first source field specifying “email” and a first source attribute value of “john@acmecorp.com” for a first user (e.g., “John Smith”); and access a second object defining the first source field and a second source attribute value of “jane@acmecorp.com” for a second user (e.g., “Jane Doe”).

In this implementation, the computer system: accesses the first object (or another object) in the first set of objects; extracts the first source field defined in the first object; and identifies a first candidate standard field—corresponding to the first source field—based on the transform model.

For example, the computer system can: extract the first source field specifying “email”; and identify the first candidate standard field specifying “user_emailwork” based on the transform model.

### 6.2 Candidate Standard Field Confidence

In one implementation, the computer system can: calculate a confidence score for a particular mapping between a source field and a standard field; and access a first confidence score threshold associated with the first candidate standard field.

In particular, the computer system can: extract the first source field from the first object; identify a first candidate standard field of a first attribute type and corresponding to the first source field based on the transform model; access a first confidence score threshold associated with the first candidate standard field based on the first attribute type; calculate a first confidence score for the first candidate standard field based on the transform model; and define the first transformation between the first source field and the first standard field in response to the first confidence score exceeding a threshold confidence score.

In one implementation, the transform model defines a set of confidence score thresholds, such as based on the candidate standard field. In this implementation, the computer system can: calculate a confidence score for the first standard field based on the transform model; access a confidence score threshold associated with the first standard field and defined by the transform model; and define the first transformation between the first source field and the first standard field in response to the first confidence score exceeding the confidence score threshold.

For example, in this implementation, the computer system can: calculate a confidence score (e.g., “99%”, “80%”, “0.89”) representing a confidence in a particular mapping (or transformation) from a first source field to a first (candidate) standard field; present the confidence score to a user, via a user portal, with the particular mapping for the first source; access a confidence score threshold (e.g., “75%”, “0.75”) defined by the transform model; and, in response to the confidence score falling below the confidence score threshold, prompt a user to confirm or reject the mapping, such as by confirming or rejecting the first (candidate) standard field.

Alternatively, the computer system can: receive a second candidate transformation from the operator (e.g., via the operator interface); and associate the second candidate transformation with the first mapping between the first source field and the first candidate standard field.

In particular, in response to the confidence score falling below the threshold confidence score, the computer system can: prompt an operator to confirm/reject the mapping; and/or receive a manual mapping definition from the operator. More specifically, the operator may input manual mappings, from source fields to standard fields, and the computer system can store these manual mappings in the transform model to later implement for objects associated with sources characterized by these manual mappings.

In one example, in response to extracting a second first source field specifying “phone” from the first object, the computer system: identifies a second candidate standard field specifying “user_phone”—and associated with a “phone number” attribute type—based on the transform model; and accesses a first confidence score threshold (e.g., a “low” confidence score threshold, “60%”) based on the “phone number” attribute type.

In another example, in response to extracting a third first source field specifying “SSN” from the first object, the computer system: identifies a third candidate standard field specifying “user_SSN”—and associated with a “social security number” attribute type—based on the transform model; and accesses a second confidence score threshold (e.g., a “high” confidence score threshold, “90%”) based on the “social security number” attribute type.

In this implementation, the computer system can access a set of confidence score thresholds—assigned to a set of attribute types—predefined by an operator and/or a policy for the computer network. Additionally or alternatively, the computer system can define the set of confidence score thresholds assigned to the set of attribute types in the transform model.

In another implementation, the computer system calculates a first confidence score for the first candidate standard field based on the transform model, the first confidence score representing a probability of correct identification of a standard field corresponding to a source field according to the transform model. In response to the first confidence score exceeding the first confidence score threshold, the computer system can define a first mapping between the first source field and the first candidate standard field. However, in response to the first confidence score falling below the first confidence score threshold, the computer system can prompt an operator to confirm the first mapping between the first source field and the first candidate standard field, such as via an operator interface.

Accordingly, the computer system can: identify an attribute type corresponding to a source field; access a confidence score threshold based on the attribute type; identify a candidate standard field corresponding to the source field; calculate a confidence score for the candidate standard field; and prompt a user for confirmation of the candidate standard field in response to the confidence score falling below the confidence score threshold for the attribute type. Therefore, the computer system can: set the confidence score threshold based on associated risk of the attribute type (e.g., “low-risk” informational attribute types, “high-risk” critical or sensitive attribute types); increase automation for mappings associated with “low-risk” attribute types; and improve accuracy of mappings associated with “high-risk” attribute types.

### 6.3 Candidate Standard Field Based on Source Attribute Value

In one variation, the computer system executes the foregoing methods and techniques: to extract the first source field from the first object; to identify the first candidate standard field associated with a first attribute type and corresponding to the first source field based on the transform model; to access the first confidence score threshold associated with the first candidate standard field based on the first attribute type; and to calculate the first confidence score for the first candidate standard field based on the transform model.

In this variation, the computer system: extracts the first source attribute value from the first object; extracts the second source attribute value from the second object; and identifies a second candidate standard field—associated with a second attribute type and corresponding to the first source attribute value and the second source attribute value—based on the transform model.

The computer system can execute similar methods and techniques described above: to access a second confidence score threshold associated with the second candidate standard field based on the second attribute type; and to calculate a second confidence score for the second candidate standard field based on the transform model.

Then, the computer system can calculate a first composite confidence score for the first candidate standard field based on the first candidate standard field, the second candidate standard field, the first confidence score, and/or the second confidence score.

In one example, the computer system: calculates an average confidence score—based on the first confidence score and the second confidence score—corresponding to 87%; and calculates the first composite confidence score corresponding to 90% in response to detecting that the first candidate standard field and the second candidate standard field are identical and based on the average confidence score.

In another example, the computer system: calculates the average confidence score—based on the first confidence score and the second confidence score—corresponding to 87%; and calculates the first composite confidence score corresponding to 50% in response to detecting that the first candidate standard field and the second candidate standard field are different.

Then, the computer system can calculate a first composite confidence score for the first candidate standard field based on the first candidate standard field, the second candidate standard field, the first confidence score, and/or the second confidence score.

In this variation, in response to the first composite confidence score exceeding the first confidence score threshold and the second confidence score threshold, the computer system can define the first mapping between the first source field and the first candidate standard field.

However, in response to the first composite confidence score falling below the first confidence score threshold and/or the second confidence score threshold, the computer system can prompt the operator to confirm the first mapping between the first source field and the first candidate standard field, such as via the operator interface.

The computer system can define the first mapping between the first source field and the first candidate standard field in response to confirmation of the first mapping by the operator.

Alternatively, in response to confirmation of a second mapping between the first source field and the second candidate standard field, the computer system can define (or store) the second mapping.

### 6.3.1 Example: Phone Number

In one example, the computer system can: identify a first source field as a phone number field; identify the first source attribute as a personal identification number (e.g., a Social Security Number); identify the first source field as an identification number field (e.g., “user_snn”); and define the first mapping as a mapping from the source phone number field to a standard identification number field.

In particular, the computer system can: access the first object representing the first attribute defining the first source field including a phone number field and the first source attribute value corresponding to the first source field and including a first string of numbers; based on the transform model, identify the first string of numbers as a personal identification number; identify the first standard field as a standard personal identification number field; define the first transformation between the first source field and the first standard field to transform the phone number field, corresponding to the first source, to the standard personal identification number field; identify the first identity based on the first string of numbers corresponding to a known personal identification number associated with the first identity; and, in response to identifying the first identity, store the first string of numbers in the standard personal identification number field associated with the first identity data container.

More specifically, the computer system: accesses a first object defining a first source field specifying “phone” and a first source attribute value of “123-45-6789” for a first user; and accesses a second object defining the first source field and a second source attribute value of “098-76-5432” for a second user.

In response to extracting the first source field specifying “phone” from the first object, the computer system: identifies a first candidate standard field specifying “user_phone”—and associated with a “phone number” attribute type—based on the transform model; accesses a first confidence score threshold (e.g., 60%) based on the “phone number” attribute type; and calculates a first confidence score (e.g., 90%) for the first candidate standard field.

In this example, the computer system: extracts the first source attribute value of “123-45-6789” defined in the first object; extracts the second source attribute value of “098-76-5432” defined in the second object; correlates the first source attribute value and the second source attribute value with a “social security number” attribute type based on the transform model; and identifies a second candidate standard field specifying “user_ssn”—associated with the “social security number” attribute type—based on the transform model; accesses a second confidence score threshold (e.g., 90%) based on the “social security number” attribute type; calculates a second confidence score (e.g., 90%) for the second candidate standard field; and calculates a first composite confidence score (e.g., 65%) based on the first candidate standard field, the second candidate standard field, the first confidence score, and/or the second confidence score.

In response to the first composite confidence score exceeding the first confidence score threshold and falling below the second confidence score threshold, the computer system prompts the operator to confirm a first mapping between the first source field and the first candidate standard field.

More specifically, the computer system can: generate a visualization depicting the first source field, a first mapping between the first source field and the first candidate standard field, the first confidence score, a second mapping between the first source field and the second candidate standard field, the second confidence score, and/or the first composite score. In this example, the computer system defines (or stores) the second mapping between the first source field and the second candidate standard field in response to confirmation of the second mapping by the operator.

### 7. Source-Standard Attribute Value Mapping Schema

Generally, the computer system can: access the transform model; access an object generated by a target source; extract a set of source attribute values from the object; identify a set of candidate transformations for the set of source attribute values based on the transform model; calculate a second set of confidence scores for the set of candidate transformations; and associate the set of transformations with a set of mappings between source fields and candidate standard fields.

The computer system can: generate a visualization depicting a set of mappings between source fields and candidate standard fields, the set of transformations associated with the set of mappings between source fields and candidate standard fields, a first set of confidence scores for the set of candidate standard fields, and the second set of confidence scores for the set of candidate transformations; and serve the visualization to an operator via an operator interface.

### 7.1 Candidate Transformation

In one implementation, the computer system: accesses a first set of objects generated by a first source; accesses a first object in the first set of objects; extracts a first source field defined in the first object; extracts a first source attribute value defined in the first object; and identifies a first candidate transformation—for the first source attribute value—based on the transform model, the first source field, and/or the first source attribute value.

In one example, the computer system: extracts the first source field specifying “email”; extracts the first source attribute specifying “john(at)acmecorp(dot)com”; and, based on the transform model, identifies the first candidate transformation specifying replacement of “(at)” with “@” and replacement of “(dot)” with “.”.

In another example, the computer system: extracts the first source field specifying “healthid”; and, based on the transform model, identifies the first candidate transformation specifying obfuscation of the first source attribute value, such as by hashing the first source attribute value, replacing each character of the first source attribute value with a special character (e.g., *), etc.

### 7.2 Candidate Transformation Confidence

In another implementation, the computer system executes the foregoing methods and techniques: to extract the first source field from the first object; to identify a first candidate standard field associated with a first attribute type and corresponding to the first source field based on the transform model; to access a third confidence score threshold based on the first attribute type; and to calculate a third confidence score for the first candidate transformation.

In response to the third confidence score exceeding the third confidence score threshold, the computer system can associate the first candidate transformation with a first mapping between the first source field and the first candidate standard field.

However, in response to the third confidence score exceeding the third confidence score threshold, the computer system can: generate a first candidate standard value based on the first source attribute value and the first candidate transformation; prompt the operator to confirm the first candidate transformation based on the first candidate standard value; and associate the first candidate transformation with the first mapping in response to confirmation of the first candidate transformation by the operator.

### 8. Data Ingestion and Mapping Application

Generally, the computer system can: access the set of mappings (e.g., defined by the transform model) that transform source attributes represented in objects generated by a source into standard attributes; and access a set of objects generated by the source during a target time interval. Then, for each object in the set of objects, the computer system: extracts a set of source attributes represented by the object; transforms the set of source attributes into a set of standard attributes according to the set of mappings; identifies a user associated with the set of standard attributes; accesses (or generates) a user container (or data container) corresponding to the user; and stores the set of standard attributes into the user container.

In one implementation, the computer system: extracts a first source field represented by a first object; and transforms the first source field into a first standard field according to a first mapping (e.g., transformation), in the set of mappings, between the first source field and the first standard field. In this implementation, the computer system can execute the foregoing methods and techniques for each source field in a set of source fields represented by the first object and for each object in the set of objects: to extract a source field represented by the object; and to transform the source field into a standard field according to a mapping in the set of mappings between the source field and the standard field.

For example, in response to defining the first transformation, the computer system can: access a second set of objects generated by the first set of sources connected to the computer network during a second time interval, the second set of objects including a second object: generated by the first source; and representing a second attribute defining the first source field and a second source attribute value corresponding to the first source field; map the second source attribute value to the first standard field based on the first transformation; identify a second identity, characterized by the second source attribute value, in the set of identities associated with the computer network; and store the second source attribute value in a second identity data container representing the second identity, the second source attribute value corresponding to the first standard field.

In this example, the computer system can associate the first transformation with the first source during a first time interval. Therefore, for a second set of objects, generated by the first source during a second time interval succeeding the first time interval, the computer system can: automatically detect the first source field for objects in the second set of objects; and, in response to detecting the first source field, automatically map attribute values associated with the first source field to the first standard field.

In another implementation, the computer system: extracts a first source attribute value represented by the first object; and generates a first standard attribute value by transforming the first source attribute value into the first standard attribute value according to a first transformation associated with the first mapping.

In this implementation, the computer system can execute the foregoing methods and techniques for each source field in a set of source fields represented by the first object and for each object in the set of objects: to extract a source attribute value represented by the object; and to generate a standard attribute value by transforming the source attribute value into the standard attribute value according to a transformation associated with a mapping in the set of mappings.

The computer system can execute methods and techniques described in U.S. patent application Ser. No. 18/983,148: to store activity (or “events”) associated with the set of resources—and attributed to a user—connected to the computer network during the target time interval in a user profile associated with the user; to access a set of entitlements assigned to the user based on a set of policies and the standard attributes of the user; to detect deviation between the activity by the user and the permitted activity represented by the set of entitlements; to generate a recommendation (e.g., a recommended policy) to respond to the deviation; and to serve the recommendation to an operator via an operator portal.

### 9. User Feedback and Transform Model Update

As described above, the computer system can: generate a visualization depicting a set of mappings between source fields and candidate standard fields, the set of the set of transformations associated with the set of mappings between source fields and candidate standard fields, a first set of confidence scores for the set of candidate standard fields, and/or the second set of confidence scores for the set of candidate transformations; and serve the visualization to an operator via an operator interface.

Additionally, the computer system can prompt the operator to confirm these mappings and/or these transformations.

In one implementation, the computer system can: receive feedback (e.g., confirmations, rejections, other responses) from the operator corresponding to these prompts; and update (e.g., train, fine-tune) the transform based on this feedback.

In particular, in this implementation, the computer system can: detect a similarity between the first source attribute value and the second source attribute value; in response to the similarity exceeding a threshold similarity, generate a prompt to an operator to confirm deletion of the second source attribute value from the first standard field; transmit the prompt to an operator via an operator portal; and, in response to receiving confirmation from the operator, remove the second source attribute value from the first standard field in the first identity data container and maintain the first source attribute value for the first standard field in the first identity data container.

In a similar variation, the computer system can resolve a discrepancy between a first attribute and a second attribute based on weights (e.g., “priority”) assigned to sources. In particular, the computer system can detect: a first attribute based on a first object from a first source associated with a first weight; and a second attribute based on a second object from a second source associated with a second weight falling below the first weight. In response to detecting a deviation between the first attribute and the second attribute, the computer system can: flag the deviation for review by an operator; store the deviation for contextual augmentation of later data ingestion; and/or recommend a remediation action (e.g., create a remediation ticket, automatically apply a correction based on granted system access levels).

In particular, the computer system can implement machine learning models (e.g., natural language processing, natural language understanding) to detect field-mapping errors. In particular, the computer system can: store the set of objects for a target time period (e.g., 6 months, 24 months), including the source attribute field and the source attribute value, for validation of later data ingestion and/or error correction. Accordingly, the computer system can include and/or interface with a state-management engine to: track attribute changes; preserve historic states of objects or configurations; and facilitate manual and/or rules-based error management in response to mapping and/or transformation errors.

### 10. Mapping Update

In one implementation, the computer system can repeat the foregoing methods and techniques: to access a second set of objects generated by the source during a second time interval succeeding the first time interval; to extract a second set of source attributes represented by objects in the second set of objects; and to generate (or update) the set of mappings that transform the second set of source attributes into a second set of standard attributes.

In one example, the computer system: accesses a third object in the second set of objects generated by the source during the second time interval; extracts a second source field defined in the third object, the second source field formatted in a second character set different from a first character set in which a first source field—defined in a first object in the first set of objects generated by the source during the first time interval—is formatted; identifies a third candidate standard field—corresponding to the second source field and formatted in the first character set—based on the transform model; calculates a third confidence score for the third candidate standard field; and defines a third mapping between the second source field and the third candidate standard field.

Additionally, the computer system can: extract a third source attribute value defined in the third object; identify a third candidate transformation—for the third source attribute value—based on the transform model, the third source field, and/or the third source attribute value; calculate a fourth confidence score for the third candidate transformation; and associate the third candidate transformation with the third mapping between the second source field and the third candidate standard field.

In one implementation, the computer system can implement entropy-based anomaly detection to detect transformation drift over time. In particular, the computer system can: scan outputs of the transformation model according to a scanning schedule (e.g., once a week, once a day); and, in response to detecting drift of these outputs, prompt the transform model to undergo retraining. In one example, the transform model can be retrained based on: versioning; blue-green deployment; canary testing; and/or Git-based rollback.

### 11. User Identification

Generally, the computer system can identify a particular identity, represented by a set of attributes, based on these normalized attributes.

In particular, for a first source attribute value, the computer system can: identify a first identity, characterized by the first source attribute value, in a set of identities associated with the computer network; and store the first source attribute value in a first identity data container representing the first identity, the first source attribute value corresponding to the first standard field.

In one implementation, the computer system can identify a correlation between the first identity (e.g., “John Smith”) and the source attribute value based on language signals extracted from the source attribute value (e.g., john@acmeco.com; johnsmith4). In another implementation, the computer system can implement a large language model (or other machine learning model) to: correlate language signals, extracted from source attribute values, to a first identity in the set of identities; calculate a confidence score for the first identity based on these correlations; and, in response to the confidence score exceeding a threshold confidence score, store the source attribute value in a data container associated with the first identity.

The computer system can repeat the foregoing methods and techniques for each identity in a set of identities associated with the computer network and for each source attribute value extracted from the set of sources during a target time period. Therefore, the computer system can generate a set of identity data containers, representing the set of identities, based on correlating source attribute values with attributes of these identities.

### 12. Policies

Generally, the computer system can: ingest a set of policies; and map policies, in the set of policies, to identities in the set of identities. In particular, the computer system can: access a set of policies associated with the computer network, the set of policies governing identity permissions and actions within the computer network; and identify a first policy, in the set of policies, valid for the first identity based on the first identity data container.

In one example, the computer system can identify the policy as valid for (e.g., applying to, governing, associated with) the first identity based on a role associated with (e.g., assigned to) the first identity and stored in the identity data container. In a similar example, the computer system can identify the policy as valid for the first identity based on a group associated with (e.g., assigned to) the first identity and stored in the identity data container. In yet another similar example, the computer system can identify the policy as valid for the first identity based on an account type associated with (e.g., assigned to) the first identity, and particularly the account being evaluated, and stored in the identity data container. In particular, in the foregoing examples, the computer system can: select an attribute (e.g., role, group, account, identification number, email address, location, IP address, phone number) from an identity data container; scan a set of policies for the attribute in the identity data container; and, in response to detecting the attribute in a first policy, in the set of policies, identifying (e.g., selecting) the first policy.

In one implementation, each policy in the set of policies defines a set of entitlements, granting permission to a first identity in the set of identities to access a first resource, in a set of resources associated with the computer network, according to a first access level. The computer system can then extract the set of entitlements from the set of policies and map entitlements to identities in Block S144.

In this implementation, the computer system can: access a policy defining an entitlement; identify an identity (e.g., an account, a role, a group) associated with the entitlement; and store the entitlement in a container (e.g., an account container, a role container, a group container) corresponding to the identity. More specifically, the computer system accesses (or ingests) a policy document affiliated with an organization and including a set of policies, each policy—in the set of policies—defining an entitlement(s) associated with a target identity in the organization's computer network.

For example, the computer system can access the set of policies including an identity-based policy—associated with an individual identity (e.g., an account(s), a group(s), a role(s))—defining an action that is permitted to execute on a resource. In particular, the computer system can access a first policy specifying that a first account is permitted to read and write data in a first folder.

In another implementation, the computer system can access the set of policies including a resource-based policy—associated with a resource—defining a set of identities granted permission to access the resource. For example, the computer system can access a second policy specifying that a first role is permitted to read data in a second data store. In this example, the computer system can identify a first role associated with the first identity, such as based on a known personal identification number of the identity; and identify the first policy, for the first identity, based on the first policy valid for the first role.

In yet another implementation, the computer system can access the set of policies including a role-based policy—associated with a role—defining a set of permissions granted to identities (e.g., accounts, groups) assigned the role. For example, the computer system can access a third policy specifying assignment of a second role—exhibiting full access to resources—to an administrator group. In another implementation, the computer system can access the set of policies including a permission boundary policy—associated with an identity—defining a limit (or range) of permissions granted to an identity. For example, the computer system can access a fourth policy specifying that a third role is permitted read-only access to a first subset of resources.

For example, the computer system can: parse the policy document; detect the first policy specifying that a first identity (e.g., a first account) is permitted to read and write data in the first folder; access a first identity container associated with the first identity; and store the first entitlement—representing permission to read and write data in the first folder—into the first identity container. Additionally or alternatively, the computer system can store the first entitlement into a data repository different from the first account container, such as an entitlement container.

Accordingly, the computer system can: parse a policy document including a set of policies; extract entitlements from the set of policies; and automatically map these entitlements to identities (e.g., to containers corresponding to these identities) within an organization's computer network.

### 12.1 Access Level Extraction

In one implementation, for each policy in the set of policies, the computer system: identifies an entitlement, defined by the policy, and an identity (or identities) associated with the entitlement; accesses a container associated with the identity; and stores the entitlement into the container. In particular, the computer system can: parse a first policy (or the policy document); detect a first set of language signals in the first policy; access a model (e.g., a large-language model) correlating language signals with entitlements and/or identities; and, based on the model, correlate the first set of language signals with a first entitlement and a first identity associated with the first entitlement; identify the first identity as a target identity associated with the first entitlement; and associate the first entitlement with the first identity.

For example, the computer system can: parse the policy document; detect the first policy specifying that the first identity is permitted to read and write data in the first folder; access a first identity container associated with the first identity; and store the first entitlement—representing permission to read and write data in the first folder—into the first identity data container. Accordingly, the computer system can: parse a policy document including a set of policies; extract entitlements from the set of policies; and automatically map these entitlements to identities (e.g., to containers corresponding to these identities) within an organization's computer network. Therefore, the computer system can ensure that entitlements specified in the policy document are selectively associated with identities within the computer network in order to detect policy violations and/or control access to resources connected to the computer network.

In one implementation, the computer system can: access a first object representing the first attribute defining the first source field including an access level field and the first source attribute value corresponding to the first source field, the first source attribute value including a first access level; extract a first entitlement from the first policy, the first entitlement granting permission to the first identity to access a first resource according to a second access level, the first resource characterized by a first criticality level; and detect a deviation between the first access level and the second access level.

Therefore, in this implementation, the computer system can: identify access levels for particular identities based on access levels defined in sources; and detect deviations from permitted access levels based on these access levels defined in source data.

### 12.2 Variation: Event Data

In one variation, the computer system can: detect an access level associated with an identity based on event data (e.g., activity by the identity on a resource); detect a deviation between the access level and a permitted access level defined by an entitlement; and generate a prompt to an operator to investigate the deviation. In particular, in this variation, the computer system can: access the first set of objects including the first object defining the first source attribute value including a first access level associated with a first resource; access a second set of objects generated by a second set of sources during the first time interval; extract a first set of event data from the second set of objects, the first set of event data representing activity by the first identity with the first resource; identify a first set of access attempts, characterized by a second access level, from the second set of objects; detect a deviation between the first access level and the second access level; generate a prompt including a policy update recommendation based on the deviation between the first access level and the second access level; and transmit the prompt to an operator via an operator interface.

In this implementation, the computer system can further update an event log, tracking changes enacted on the computer network, with implementation of a new policy in response to confirmation by an operator—such as for proper data maintenance and audit tracking.

In particular, the computer system can: receive confirmation of the policy update recommendation by the operator; generate a second policy based on the policy update recommendation; and annotate the set of policies with the second policy. The computer system can then, such as in response to annotating the set of policies, generate an event log entry including: an identification code representing the operator; a description of the second policy; and a timestamp associated with confirmation of the policy update recommendation. The computer system can then update an event log, including changes associated with the computer network, with the event log entry.

Accordingly, in this implementation, the computer system can: detect real-time access levels associated with access attempts of identities accessing resources on the computer network; and detect deviations between these access levels and permitted access levels, defined in entitlements extracted from policies.

### 13. Posture

Generally, the computer system can calculate posture scores for identities connected to the computer network, these posture scores characterizing a risk level (or score) posed to the computer network and attributed to the identity, and in particular a risk level posed to the computer network should a bad actor infiltrate the computer network via the particular identity. In particular, the computer system can: calculate a first posture score for the first identity based on correspondence between the first policy and the first source attribute value; and, in response to the first posture score exceeding a threshold posture score, flag the first identity for review by security personnel associated with the computer network.

In one implementation, the computer system can: access a first set of objects generated by a source and representing a set of identities associated with a computer network; and detect the set of identities based on the first set of objects. The computer system can then: access a first policy associated with the computer network; and extract a first entitlement from the first policy, the first entitlement granting permission to a first identity in the set of identities to access a first resource, in a set of resources associated with the computer network, according to a first access level. Then, in response to extracting the first entitlement, the computer system: calculates a first posture score for the first identity based on the first access level and a first sensitivity level associated with the first resource; and, in response the first posture score exceeding a threshold posture score, flag the first identity for review for security personnel and/or assign a critical level to the identity.

Additionally or alternatively, the computer system calculates the first posture score based on an access level (e.g., read-only access, read-write access, administrator access) for each access right in the first set of access rights. In particular, the computer system can: detect a deviation between a first access level (e.g., a granted access level based on policies) and a second access level (e.g., detected by sources) for a first resource; and calculate the first posture score based on a deviation between the first access level and the second access level and a first criticality level associated with the first resource.

In one implementation, the computer system can: identify a target attribute value for the first standard field for the first identity; characterize a deviation between the target attribute value and the first standard attribute value; and calculate the first posture score for the first identity based on the deviation between the target attribute value and the first standard attribute value. In this implementation, the computer system can then: generate a prompt to investigate the deviation between the target attribute value and the first standard attribute value for the first identity; and transmit the prompt to an operator via an operator interface.

For example, the computer system can, in response to the first posture score exceeding the threshold posture score: identify a target attribute value for a second standard field for the first identity (e.g., based on the first policy, based on a second policy in the set of policies); identify a second standard attribute value, corresponding to the second standard field, in the identity data container; characterize (e.g., identify, detect) a deviation between the target attribute value and the second standard attribute value; generate a prompt to investigate the deviation between the target attribute value and the second standard attribute value for the first identity; and transmit the prompt to an operator via an operator interface.

In one variation, the computer system can characterize a posture representation (e.g., characteristic, attribute) for a particular identity. In particular, the computer system can characterize a posture characteristic for a first identity based on: a set of attributes in an identity data container associated with the first identity; and/or correlation between attributes in the set of attributes with target attributes defined by policies in the set of policies. In this variation, a posture representation can include: a critical status (e.g., a posture score exceeding a threshold posture score); a compliant status (e.g., a posture score falling below the threshold posture score); and/or an enforce status.

In one variation, the computer system can: calculate the first posture score based on the first access level, the second access level, and a first criticality level defined by the first resource; identify the first set of access attempts characterized by the second access level exceeding the first access level; and, in response to the first posture score exceeding the threshold posture score, generate a recommendation to reduce the second access level to the first access level. In this variation, the computer system can automatically detect a policy violation, represented by the deviation between the first access level and the second access level, and generate a prompt to an operator to reduce the second access level, currently associated with the first identity, to the first access level, granted to the first identity based on the first policy. Additionally or alternatively, the computer system can automatically reduce the second access level to the first access level in response to detecting the deviation.

For each identity in the set of identities, the computer system repeats the foregoing methods and techniques to calculate a posture score, in a set of posture scores, for the identity based on a set of access rights assigned to the identity. In particular, the computer system can, for each identity in the set of identities associated with the computer network: generate an identity data container representing attributes extracted from objects generated by the first set of sources during the first time interval; calculate a posture score, in a set of posture scores, based on the identity data container; and, in response to the posture score exceeding the threshold posture score, flag the identity for review by security personnel associated with the computer network. The computer system can then: generate a visualization representing a subset of identities, in the set of identities, the subset of identities characterized by posture scores exceeding the threshold posture score in Block S180; and transmit the visualization to an operator via an operator interface in Block S182 In particular, the computer system can transmit the visualization to a particular operator associated with the posture scores exceeding the threshold posture score. For example, a first identity is characterized by a first posture score exceeding the threshold posture score based on an access level deviation. The computer system can identify a relevant group for access level deviations, and transmit the visualization, including a representation of the first identity, to the relevant group.

Accordingly, the computer system can implement visualization techniques for clarity and usability to thereby generate prioritized multi-layer alerts (e.g., recommendations, security alerts, compliance violations), routed automatically to relevant operational teams (e.g., IAM, security, GRC), for policy deviations. Additionally, the computer system can highlight (e.g., risk or posture ratings) flagged identities and cluster (e.g., dynamic clustering) identities based on policy deviation types to thereby maintain clear visualizations at multiple organizational and data complexity levels.

In a similar implementation, the computer system: generates a visualization selectively indicating the set of identities and the set of posture scores; and serves the visualization to an operator via an operator interface. Therefore, the computer system can: characterize levels of risk posed to the computer network by the set of identities based on access rights assigned to these identities and/or event data performed by these identities; and notify the operator of these levels of risk in order to enable the operator to prioritize and execute actions according to risk.

### 14. Policy Recommendations

Generally, in response to detecting a deviation between the activity by the account and the permitted activity represented by the set of entitlements, the computer system can: generate a recommendation (e.g., a recommended policy) to respond to the deviation; and serve the recommendation to an operator via an operator portal. Additionally, the computer system can: generate a notification specifying the deviation; and serve the notification to the operator via the operator portal. For example, the computer system can generate the notification specifying the deviation (e.g., a policy violation).

In one implementation, the computer system can generate policies and/or policy update recommendations based on detected deviations from current policies.

In one example, the deviation represents an access level deviation, such as a detected access level exceeding a permitted access level. In this example, the computer system can: detect the deviation; generate a recommendation to reduce the detected access level to the permitted access level; and/or automatically reduce the detected access level to the permitted access level.

In a similar example, the deviation represents an account count deviation, such as a detected account count (e.g., two, three) exceeding a permitted account count (e.g., one). In this example, the computer system can: detect the deviation; generate a recommendation to reduce the detected account count to the permitted account count, such as by deleting particular accounts; and/or automatically reduce the detected account count to the permitted account count.

In yet another similar example, deviation represents an access count deviation, such as a detected access count (e.g., hundreds, thousands) exceeding a permitted (or expected) access count (e.g., ten, fifty). In this example, the computer system can: detect the deviation; generate a recommendation to investigate the identity, such as by quarantining the identity (e.g., reducing all access levels to no access); and/or automatically flagging the identity as compromised and quarantining the identity.

Accordingly, in this implementation, the computer system can detect unique policy violations via detecting deviations from detected values and permitted values; interpret these deviations as policy violations; and recommend policy updates and/or computer network updates based on these deviations to reduce risk of unauthorized access to resources and increase overall security of the computer network by limiting access rights for each account.

### 15. Variation: Sensitive Data Detection

Generally, in response to detecting a particular source attribute value as sensitive data, the computer system can prompt a user to confirm a particular action to redact the source attribute value. In particular, sensitive data can include personally identifiable information (e.g., phone number, social security number, address).

In response to detecting sensitive data, the computer system can: automatically redact an attribute value, corresponding to a source field, irrespective of the source field (e.g., a source field represents non-sensitive data, an attribute value associated with the source field represents sensitive data); and/or prompt a user to select an action for this sensitive data (e.g., delete, redact, encrypt).

In particular, in response to generating the set of candidate standard fields and in response to detecting a particular attribute value, associated with a first source field, as sensitive data, the computer system can: prompt a user to select an action for the particular attribute value; store the action in the transform value; and, in response to detecting the first source field in a second set of objects, automatically apply the action to attribute values corresponding to this source field.

In one example, in response to detecting a particular attribute value, associated with a first source field, as sensitive data, a user may select redaction of the particular attribute value, and the computer system can redact the particular attribute value from the first set of objects. During a second time period, the computer system can: access a second set of objects generated by the first source; detect the first source field; and automatically redact attribute values corresponding to this first source field based on user selection of redaction of this sensitive data.

In another example, in response to detecting a particular attribute value, associated with a first source field, as sensitive data, a user may select deletion (e.g., “dropping”) of the particular attribute value, and the computer system can delete the particular attribute value from the first set of objects. During a second time period, the computer system can: access a second set of objects generated by the first source; detect the first source field; and automatically delete attribute values corresponding to this first source field based on user selection of redaction of this sensitive data.

Therefore, in this variation, the computer system can: detect sensitive data in any source field ingested from a set of sources as a set of objects; prompt a user to select a particular remedial action for these sensitive data; and store the action selected by the user and automatically apply this action to other sensitive data ingested from this source to thereby maintain compliance with regulations around storage of sensitive data.

### 16. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods S100 of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising, during a first time period:
accessing a first set of objects generated by a first set of sources connected to a computer network during a first time interval, the first set of objects comprising a first object:
generated by a first source; and
defining:
a first source field; and
a first source attribute value corresponding to the first source field;
defining a first transformation between the first source field and a first standard field, in a standard format;
mapping the first source attribute value to the first standard field;
identifying a first identity, characterized by the first source attribute value, in a set of identities associated with the computer network;
storing the first source attribute value in a first identity data container representing the first identity, the first source attribute value corresponding to the first standard field;
accessing a set of policies associated with the computer network, the set of policies governing identity permissions and actions within the computer network;
identifying a first policy, in the set of policies, valid for the first identity based on the first identity data container;
calculating a first posture score for the first identity based on correspondence between the first policy and the first source attribute value; and
in response to the first posture score exceeding a threshold posture score, flagging the first identity for review by security personnel associated with the computer network.

2. The method of claim 1:
wherein calculating the first posture score for the first identity comprises:
identifying a target attribute value for the first standard field for the first identity from the first policy;
characterizing a deviation between the target attribute value and the first standard attribute value; and
calculating the first posture score for the first identity proportional to the deviation between the target attribute value and the first standard attribute value; and
wherein flagging the first identity for review by security personnel associated with the computer network comprises:
generating a prompt to investigate the deviation between the target attribute value and the first standard attribute value; and
transmitting the prompt to an operator via an operator interface.

3. The method of claim 1:
further comprising:
accessing a second set of objects generated by a second set of sources connected to the computer network during the first time interval, the second set of objects representing activity associated with the first identity interacting with a set of resources on the computer network;
detecting a first set of access attempts associated with a first resource by the first identity based on the second set of objects;
characterizing a first access level of the first set of access attempts; and
extracting a target access level from the first policy, the target access level valid for the first identity;
wherein calculating the first posture score for the first identity comprises:
characterizing a posture representation based on a deviation between the first access level and the target access level; and
calculating the first posture score for the first identity proportional to the posture representation; and
wherein flagging the first identity for review by security personnel associated with the computer network comprises:
generating a prompt to review the first access level for the first identity based on the first policy; and
transmitting the prompt to an operator via an operator interface.

4. The method of claim 3, further comprising:
characterizing the first set of access attempts as hacking attempts based on the deviation between the first access level and the target access level;
detecting a set of accounts associated with the first identity based on the first identity data container; and
in response to characterizing the first set of access attempts as hacking attempts, quarantining the set of accounts.

5. The method of claim 1:
wherein identifying the first policy, in the set of policies, valid for the first identity comprises:
identifying a first role associated with the first identity in the first identity data container;
extracting a first set of target roles from the first policy applicable to the first set of target roles; and
in response to presence of the first role in the set of target roles, matching the first policy to the first identity; and
further comprising:
accessing a second set of objects generated by a second set of sources connected to the computer network during the first time interval, the second set of objects representing activity associated with a first set of identities interacting with a set of resources on the computer network, the first set of identities characterized by the first role;
detecting a second set of access attempts associated with the first resource by the first set of identities based on the second set of objects;
characterizing a second access level of the second set of access attempts; and
in response to detecting correspondence between the first access level and the second access level:
generating a second prompt comprising a recommendation to update the first policy to include the first access level; and
transmitting the second prompt to the operator via the operator interface.

6. The method of claim 1:
wherein identifying the first policy, in the set of policies, valid for the first identity comprises:
identifying a first role associated with the first identity in the first identity data container;
extracting a first set of target roles from the first policy applicable to the first set of target roles; and
in response to presence of the first role in the set of target roles, matching the first policy to the first identity; and
further comprising:
accessing a second set of objects generated by a second set of sources connected to the computer network during the first time interval, the second set of objects representing activity associated with a first set of identities interacting with a set of resources on the computer network, the first set of identities characterized by the first role;
detecting a second set of access attempts associated with the first resource by the first set of identities based on the second set of objects;
characterizing a second access level of the second set of access attempts; and
in response to detecting a second deviation between the first access level and the second access level:
generating a second prompt comprising a recommendation to update the first role for the first identity; and
transmitting the second prompt to the operator via the operator interface.

7. The method of claim 1:
wherein defining the first transformation between the first source field and the first standard field comprises:
extracting the first source field from the first object;
identifying a first candidate standard field of a first attribute type and corresponding to the first source field based on the transform model;
accessing a first confidence score threshold associated with the first candidate standard field based on the first attribute type;
calculating a first confidence score for accuracy of the first candidate standard field based on the transform model; and
defining the first transformation between the first source field and the first standard field in response to the first confidence score exceeding a threshold confidence score; and
further comprising, for a second object in the first set of objects:
extracting a second source field from the second object;
identifying a second candidate standard field of a second attribute type and corresponding to the second source field based on the transform model;
accessing a second confidence score threshold associated with the second candidate standard field based on the second attribute type;
calculating a second confidence score for accuracy of the second candidate standard field based on the transform model; and
in response to the second confidence score falling below the second threshold confidence score:
prompting an operator to confirm the second candidate standard field; and
in response to receiving confirmation of the second candidate standard field from the operator, defining a second transformation between the second source field and the second candidate standard field.

8. The method of claim 1, further comprising:
during a second time period preceding the first time period:
accessing a second set of objects generated by the set of sources connected to the computer network during a second time interval, the second set of objects comprising:
a second object:
generated by the first source; and
defining:
a second source field; and
a second source attribute value corresponding to the second source field; and
a third object:
generated by the first source; and
defining:
a third source field; and
a third source attribute value corresponding to the third source field;
identifying a candidate standard field corresponding to the second source field and the third source field based on correspondence between the second source attribute value and the third source attribute value;
calculating a composite confidence score for accuracy of the candidate standard field based on:
second source attribute value relative to the candidate standard field; and
third source attribute value relative to the candidate standard field;
in response to the first composite confidence score falling below a first confidence score threshold, prompting an operator to confirm a first mapping between the second source field and the candidate standard field and a second mapping between the third source field and the candidate standard field;
defining the first mapping between the second source field and the candidate standard field in response to confirmation of the first mapping by the operator;
defining the second mapping between the third source field and the candidate standard field in response to confirmation of the second mapping by the operator; and
generating the transform model based on the first mapping and the second mapping.

9. The method of claim 1:
wherein accessing the first set of objects generated by the first set of sources comprises accessing the first object defining:
the first source field comprising a phone number field; and
the first source attribute value corresponding to the first source field and comprising a first string of numbers;
wherein defining the first transformation between the first source field and the first standard field comprises:
based on the transform model, identifying the first string of numbers as a personal identification number;
identifying the first standard field as a standard personal identification number field; and
in response to detecting a deviation between the standard personal identification number field and the phone number field, defining the first transformation between the first source field and the first standard field to transform the phone number field to the standard personal identification number field;
further comprising identifying the first identity based on the first string of numbers corresponding to a known personal identification number associated with the first identity; and
wherein storing the first source attribute value in the first identity data container comprises, in response to identifying the first identity, storing the first string of numbers in the standard personal identification number field associated with the first identity data container.

10. The method of claim 9, further comprising:
accessing a second set of objects generated by the first set of sources, the second set of objects comprising a second object defining:
the phone number field; and
a second string of numbers corresponding to the phone number field;
mapping the second string of numbers to the standard personal identification number field based on the first transformation;
identifying a second identity, characterized by the second string of numbers, in the set of identities associated with the computer network; and
storing the second string of numbers in the phone number field in a second identity data container representing the second identity.

11. The method of claim 9:
accessing a second set of objects generated by the first set of sources, the second set of objects comprising a second object:
generated by a second source; and
defining:
the phone number field; and
a second string of numbers corresponding to the phone number field;
in response to identifying the second string of numbers as a phone number, defining a second transformation between the phone number field and a standard phone number field for the second source;
identifying a second identity, characterized by the second string of numbers, in the set of identities associated with the computer network; and
storing the second string of numbers in the standard phone number field in a first identity data container representing the first identity.

12. The method of claim 1:
further comprising identifying a first role associated with the first identity based on a known personal identification number representing the first identity;
wherein identifying the first policy, in the set of policies, valid for the first identity comprises:
identifying a first known personal identification number representing the first identity in the first identity data container; and
identifying the first policy based on the first policy valid for the first known personal identification number; and
further comprising:
for a second identity, in response to detecting absence of a second known personal identification number in a second identity data container representing the second identity, accessing a first role associated with the second identity based on the second identity data container; and
identifying the first policy, in the set of policies, valid for the second identity, based on the first policy valid for the first role.

13. The method of claim 1, further comprising:
accessing a second set of objects generated by the first set of sources during a second time interval, the second set of objects comprising a second object:
generated by a second source; and
defining:
a second source field; and
a second source attribute value corresponding to the second source field;
defining a second transformation between the second source field and the first standard field based on the transform model;
mapping the second source attribute value to the first standard field;
identifying the first identity based on the second source attribute value; and
storing the second source attribute value in the first identity data container representing the first identity, the second source attribute value corresponding to the first standard field.

14. The method of claim 13, further comprising:
detecting a similarity between the first source attribute value and the second source attribute value;
in response to the similarity exceeding a threshold similarity, generating a prompt to an operator to confirm deletion of the second source attribute value from the first standard field;
transmitting the prompt to an operator via an operator portal; and
in response to receiving confirmation from the operator, removing the second source attribute value from the first standard field in the first identity data container and maintaining the first source attribute value for the first standard field in the first identity data container.

15. The method of claim 1:
wherein accessing the first set of objects comprises accessing the first object:
defining:
the first source field comprising an access level field; and
the first source attribute value corresponding to the first source field, the first source attribute value comprising a first access level;
further comprising:
extracting a first entitlement from the first policy, the first entitlement granting permission to the first identity to access a first resource according to a second access level, the first resource characterized by a first criticality level; and
detecting a deviation between the first access level and the second access level; and
wherein calculating the first posture score comprises calculating the first posture score based on:
the deviation between the first access level and the second access level; and
the first criticality level.

16. A method comprising:
accessing a first set of objects generated by a first set of sources associated with a computer network during a first time interval, the first set of objects comprising a first object:
generated by a first source; and
defining:
a first source field; and
a first source attribute value corresponding to the first source field;
accessing a transform model that correlates source fields in a source format with target standard fields in a target standard format;
calculating a first confidence score for a first standard field based on the transform model and the first source field;
defining a first transformation between the first source field and the first standard field, for the first source, in response to the first confidence score exceeding a first confidence score threshold; and
for a first identity, in a set of identities, associated with the computer network:
identifying a first mapping between the first source attribute value and the first identity;
calculating a second confidence score for first mapping;
in response to the second confidence score exceeding a second confidence score threshold, storing the first source attribute value in a first identity data container representing the first identity, the first source attribute value corresponding to the first standard field;
accessing a set of policies associated with the computer network;
identifying a first policy, in the set of policies, valid for the first identity based on the first identity data container;
calculating a first posture score based on correspondence between the first policy and the first source attribute value; and
in response to the first posture score exceeding a threshold posture score, flagging the first identity for review by security personnel associated with the computer network.

17. The method of claim 16:
wherein accessing the first set of objects comprises accessing the first set of objects comprising the first object defining the first source attribute value comprising a first access level associated with a first resource; and
further comprising:
accessing a second set of objects generated by a second set of sources during the first time interval;
extracting a first set of event data from the second set of objects, the first set of event data representing activity by the first identity with the first resource;
identifying a first set of access attempts, characterized by a second access level, from the second set of objects;
detecting a deviation between the first access level and the second access level;
generating a prompt comprising a policy update recommendation based on the deviation between the first access level and the second access level; and
transmitting the prompt to an operator via an operator interface.

18. The method of claim 17, further comprising:
receiving confirmation of the policy update recommendation by the operator;
generating a second policy based on the policy update recommendation;
annotating the set of policies with the second policy;
generating an event log entry comprising:
an identification code representing the operator;
a description of the second policy; and
a timestamp associated with confirmation of the policy update recommendation; and
updating an event log with the event log entry.

19. The method of claim 17:
wherein calculating the first posture score comprises calculating the first posture score based on the first access level, the second access level, and a first criticality level defined by the first resource;
wherein identifying the first set of access attempts comprises identifying the first set of access attempts characterized by the second access level exceeding the first access level; and
further comprising, in response to the first posture score exceeding the threshold posture score, generating a recommendation to reduce the second access level to the first access level.

20. A method comprising:
accessing a first set of objects generated by a first set of sources connected to a computer network during a first time interval, the first set of objects comprising:
a first object:
generated by a first source; and
defining:
a first source field; and
a first source attribute value corresponding to the first source field;
identifying a candidate standard field corresponding to the first source field based on correspondence between the first source attribute value and a candidate attribute value;
calculating a first confidence score for the candidate standard field;
in response to the first confidence score falling below a first confidence score threshold, prompting an operator to confirm a first mapping between the first source field and the candidate standard field;
defining the first mapping between the first source field and the candidate standard field in response to confirmation of the first mapping by the operator;
identifying a first identity, characterized by the first source attribute value, in a set of identities associated with the computer network;
storing the first source attribute value in a first identity data container representing the first identity, the first source attribute value corresponding to the candidate standard field;
characterizing a posture representation for the first identity based on the first source attribute value; and
in response to the posture representation indicating a critical posture state, flagging the first identity for review by security personnel associated with the computer network.
